(19) United States
(12) Patent Application Publication
(10) Pub. No.: US 2002/0046191 A1
(43) Pub. Date: Apr. 18, 2002

(54) Apparatus and method for providing transaction cost information

(76) Inventor: Raymond Anthony Joao, Yonkers, NY (US)

Correspondence Address: RAYMOND A. JOAO, ESQ., 122 BELLEVUE PLACE, YONKERS, NY, 10703, US

(21) Appl. No.: 09/973,564

(22) Filed: Oct. 9, 2001

Related U.S. Application Data
(60) Provisional application No. 60/240,557, filed on Oct. 14, 2000.

(51) Int. Cl. G06F 17/60

(52) U.S. Cl. 705/400; 705/1

(57) ABSTRACT

An apparatus and method for providing transaction cost information, including a memory device for storing information regarding at least one of a cost of at least one of a good, a product, and a service, a shipping cost, a handling cost, a tax, a duty, a tariff, and an insurance cost, a receiver for receiving information regarding at least one of a transaction and an order involving at least one of a good(s), product(s), and a service(s), a processor for processing the information regarding a transaction in conjunction with the information regarding at least one of a cost of at least one of a good, a product, and a service, a shipping cost, a handling cost, a tax, a duty, a tariff, and an insurance cost, wherein the processor calculates a total cost of the transaction, wherein the total cost of the transaction includes a cost of the at least one of a good, a product, and a service, and any applicable at least one of a shipping cost, a handling cost, a tax, a duty, a tariff, and an insurance cost, associated with the transaction, and further wherein the processor generates a transaction total cost message, wherein the transaction total cost message contains information regarding the total cost of the transaction, and a transmitter for transmitting the transaction total cost message to a communication device associated with a user.

### BACKGROUND OF THE INVENTION

It is estimated that sixty five percent of online shoppers fill electronic shopping carts or begin to make an on-line purchase only to bail out at the point of check out. Further, it is also estimated that only 1.8% of visits to on-line retail sites result in a purchase. Some of these aborted purchases have resulted from shipping, handling, and/or other charges or costs, which have been known to add to the costs of on-line transactions, sometimes making the final cost of same unacceptable to online purchasers.

### SUMMARY OF THE INVENTION

The present invention overcomes the shortfalls of the prior art and provides an apparatus and method for providing transaction cost information which can include the total cost of the transaction, including the cost of goods, products, and/or services, and/or any one or more of any applicable shipping charges, handling charges, insurance charges, and/or any other transaction-related charges and/or costs. The present invention can determine the total transaction cost and/or the running total cost of the transaction and provide same to a purchaser in real-time as the user or purchaser is engaging in a transaction and/or while the user or purchaser is placing his or her order.

The apparatus can include a central processing computer or server computer for processing transaction information, a user computer or communication device via which the user or individual can communicate with the central processing computer, a vendor computer for providing information regarding goods, products, and/or services, which are provided by the respective vendor, as well as any vendor imposed shipping and/or handling charges or costs, and a shipper computer for providing shipping, handling, and/or insurance, information, as well as shipper imposed shipping, handling, and/or insurance, charges or costs. Any number of central processing computers, user computers, vendor computers, and/or shipper computers, can be utilized in conjunction with the present invention.

The central processing computers, user computers, vendor computers, and/or shipper computers, can communicate with any other central processing computers, user computers, vendor computers, and/or shipper computers, over any suitable communication network or system, including, but not limited to, the Internet, the World Wide Web, a telephone network, a telecommunication network, a digital communication network, a satellite communication network, a wireless communication network, a personal communication services network, a broadband communication network, a bluetooth communication network, and/or any other communication network and/or system.

Any of the central processing computers, user computers, vendor computers, and/or shipper computers, can be any computer, computer system, group of computers, telephones, personal computers, wireless telephones, personal digital assistants, video telephones, wireless devices, handheld devices, palm-top devices, and/or any other communication device(s).

The present invention provides transaction cost information to a purchaser in a real-time manner so that a purchaser can be appraised of the total transaction cost, including the cost of the good(s), product(s), and/or service(s), and any related and/or imposed shipping charges and/or costs, handling charges and/or costs, taxes, duties, tariffs, insurance charges and/or costs, and/or any other charges and/or costs related to, required by, mandated by, and/or incidental to, the transaction. The total transaction cost information can also provide information regarding a total running cost of a transaction.

The apparatus can also provide information for changing and/or modifying an order in order to meet and/or satisfy a purchaser's maximum spending limit.

The apparatus can also be programmed so as to notify a user when the collective or aggregate cost of a prospective transaction falls to a certain amount.

Accordingly, it is an object of the present invention to provide an apparatus and a method for providing transaction cost information.

It is another object of the present invention to provide an apparatus and a method for providing transaction cost information for, or relating to, an on-line transaction(s).

It is still another object of the present invention to provide an apparatus and a method for providing transaction cost information which can include any applicable shipping costs, handling costs, taxes, duties, tariffs, insurance costs, and/or other costs related to a transaction.

It is yet another object of the present invention to provide an apparatus and a method for providing transaction cost information which can provide the total transaction cost and/or a running total cost of a transaction.

It is another object of the present invention to provide an apparatus and a method for providing transaction cost information, in real-time.

It is still another object of the present invention to provide an apparatus and a method for providing transaction cost information in real-time as a purchaser is engaging in a transaction and/or is placing an order.

It is yet another object of the present invention to provide an apparatus and a method for providing transaction cost information which can be utilized on, over, or in conjunction with, any communication network or system.

It is another object of the present invention to provide an apparatus and a method for providing transaction cost information which can be utilized on, over, or in conjunction with, the Internet and/or the World Wide Web.

It is still another object of the present invention to provide an apparatus and a method for providing transaction cost information which can be utilized in order to provide or apprise a user or purchaser of a total transaction cost.

It is yet another object of the present invention to provide an apparatus and a method for providing transaction cost information which can be utilized in order to provide information regarding a total running cost of a transaction.

It is another object of the present invention to provide an apparatus and a method for providing transaction cost information which can be utilized in order to compute a total or aggregate transaction cost for all of the orders placed by a user.

It is still another object of the present invention to provide an apparatus and a method for providing transaction cost information which can compute various order combinations, options, and/or variations, involving good(s), products(s), and/or service(s), and/or any applicable shipping charges or costs, handling charges or costs, taxes, duties, tariffs, and/or insurance charges or costs.

It is yet another object of the present invention to provide an apparatus and a method for providing transaction cost information which can compute various order combinations, options, and/or variations, involving good(s), products(s), and/or service(s), in order to provide a user with an order or order combination which results in a total transaction cost which is at or below a user's defined maximum spending limit.

It is another object of the present invention to provide an apparatus and a method for providing transaction cost information which can be programmed to notify a user when a collective or aggregate cost of a prospective transaction falls to a certain amount.

It is still another object of the present invention to provide an apparatus and a method for providing transaction cost information which can be utilized in order to determine whether a user's order can be fulfilled at or below a user-defined maximum spending limit.

It is yet another object of the present invention to provide an apparatus and a method for providing transaction cost information which can detect a reduction in transaction and transaction-related charges or costs.

It is another object of the present invention to provide an apparatus and a method for providing transaction cost information which can detect a reduction in transaction and transaction-related charges or costs and determine a total or aggregate cost of an order.

It is still another object of the present invention to provide an apparatus and a method for providing transaction cost information which can utilize intelligent agents, software agents, and/or mobile agents, in order to act for, or on behalf of, any of the users of the apparatus.

It is yet another object of the present invention to provide an apparatus and a method for providing transaction cost information which can be programmed to be self-activating and/or activated automatically.

Other objects and advantages of the present invention will be apparent to those skilled in the art upon a review of the Description of the Preferred Embodiments taken in conjunction with the Drawings which follow.

### BRIEF DESCRIPTION OF THE DRAWINGS

In the Drawings:

FIG. 1 illustrates the apparatus of the present invention in block diagram form;

FIGS. 2A and 2B illustrate a preferred embodiment method for utilizing the apparatus of the present invention, in flow diagram form; and

FIG. 3 illustrates another preferred embodiment method for utilizing the apparatus of the present invention, in flow diagram form.

### DESCRIPTION OF THE PREFERRED EMBODIMENTS

The present invention provides an apparatus and method for providing transaction cost information which can include the total cost of the transaction, including the cost of goods, products, and/or services, and/or any one or more of any applicable shipping charges or costs, handling charges or costs, taxes, duties, tariffs, insurance charges or costs, and/or any other transaction charges and/or costs and/or transaction-related charges and/or costs. The present invention can determine the total transaction cost and/or the running total cost of the transaction and provide same to a purchaser in real-time as the user or purchaser is engaging in a transaction and/or placing an order.

As defined herein, the terms “user”, “purchaser”, or their plurals, refer to any user, users, purchaser, purchasers, individual, individuals, entity, entities, agent, agents, broker, brokers, and/or any third party or third parties, who or which act for or on behalf of any of the herein-described users, purchasers, individuals, entities, agents, and/or brokers.

Applicant hereby incorporates by reference herein the subject matter and teachings of U.S. Provisional Patent Application Ser. No. 60/240,557, filed Oct. 14, 2000, which teaches and discloses an apparatus and method for providing transaction cost information.

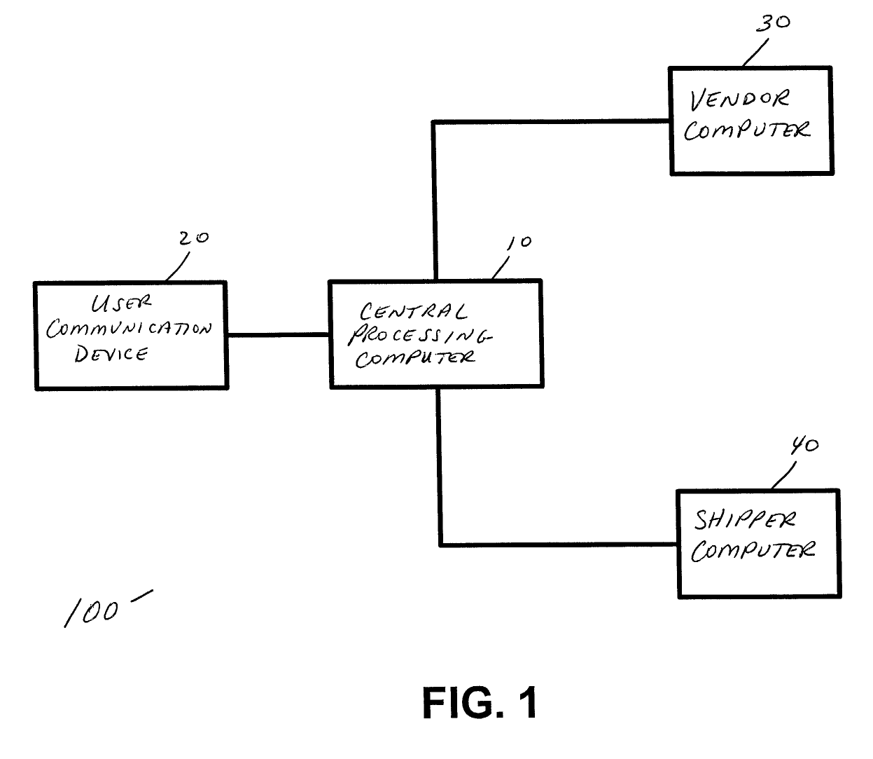

FIG. 1 illustrates the apparatus 100 of the present invention, in block diagram form. The apparatus 100 includes a central processing computer or server computer 10 for processing transaction information, a user computer of communication device 20 (hereinafter “user communication device 20”) via which the user or individual can communicate with the central processing computer 10, a vendor computer 30 for providing information regarding goods, products, and/or services, which are provided by the respective vendor as well as any vendor imposed shipping charges or costs, handling charges or costs, and/or other transaction charges or costs, and a shipper computer 40 for providing shipping, handling, and/or insurance, information, as well as any shipper imposed shipping charges or costs, handling charges or costs, insurance charges or costs, and/or any other transaction charges or costs.

Each of the central processing computers 10, the user computers 20, the vendor computers 30, and/or the shipper computers 40, can include a central processing unit (CPU), a random access memory (RAM), a read only memory (ROM), an input device, a display device, a receiver, a transmitter, a database, and an output device.

The database(s) of the central processing computer(s) 10 can include any and/or all of the data and/or information needed and/or desired for performing all of the processing routines and/or functionality described herein as being provided by the apparatus 100. The respective database(s) of the user computer(s) 20, the vendor computer(s) 30, and/or the shipper computer(s) 40, can also include any of the data and/or information which is stored in the database of the central processing computer(s) 10 any/or any other data and/or information needed and/or desired for performing any of the respective processing routines and/or functionality of the respective computer(s).

Any number of central processing computers 10, user computers 20, vendor computers 30, and/or shipper computers 40, can be utilized in conjunction with the present invention.

The central processing computers 10, the user computers 20, the vendor computers 30, and/or the shipper computers 40, can communicate with any other central processing computers 10, user computers 20, vendor computers 30, and/or shipper computers 40, over any suitable communication network or system, including, but not limited to the Internet, the World Wide Web, a telephone network, a telecommunication network, a digital communication network, a satellite communication network, a wireless communication network, a personal communication services network, a broadband communication network, a bluetooth communication network, and/or any other communication network and/or system.

Any of the central processing computers 10, user computers 20, vendor computers 30, and/or shipper computers 40, can be any computer, computer system, group of computers, telephones, personal computers, wireless telephones, personal digital assistants, video telephones, personal communication devices, wireless devices, handheld devices, palm-top devices, and/or any other communication device(s) and/or computer(s).

In a preferred embodiment, the apparatus 100 and method of the present invention can be utilized in order to provide transaction cost information to a purchaser in a real-time manner so that a user or purchaser can be provided with, or apprised of, the total transaction cost, including the cost of the good(s), product(s), and/or service(s), and any applicable, related, imposed, and/or incidental, shipping charges and/or costs, handling charges and/or costs, taxes, duties, tariffs, insurance charges and/or costs, and/or any other charges and/or costs related to, required by, mandated by, and/or incidental to, the transaction. The total transaction cost information can also provide information regarding a total running cost of a transaction. The total transaction cost information can be provided to a user or purchaser in real-time and/or otherwise. The total transaction cost information can also be provided to the user or purchaser prior to, contemporaneously with, and/or subsequent to, engaging in a transaction.

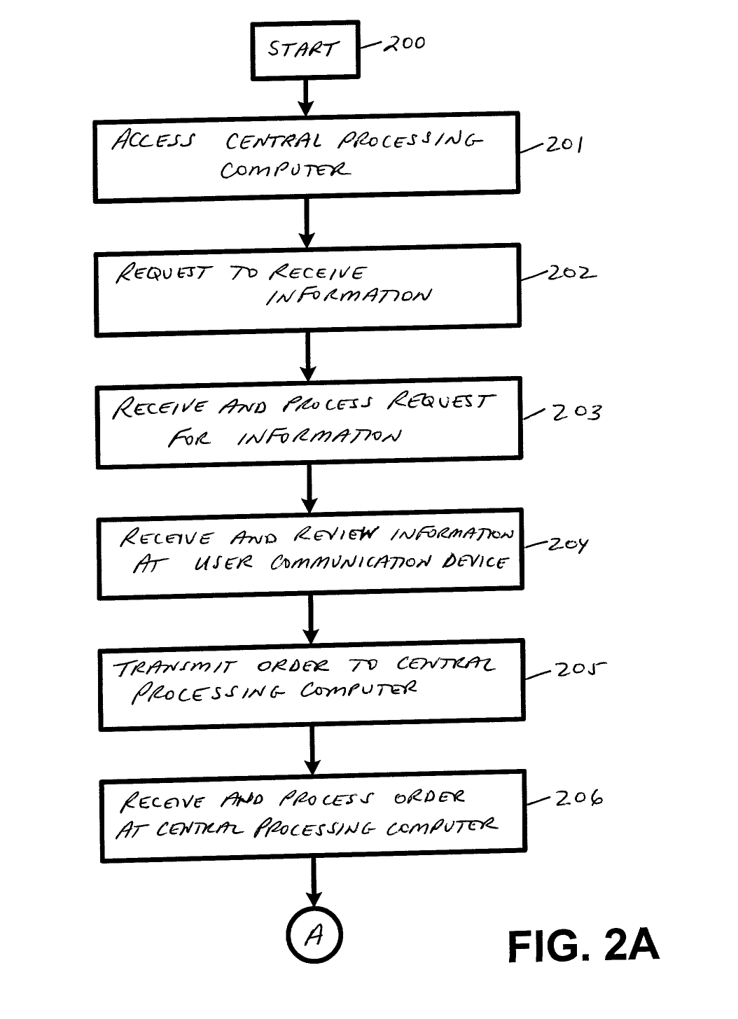

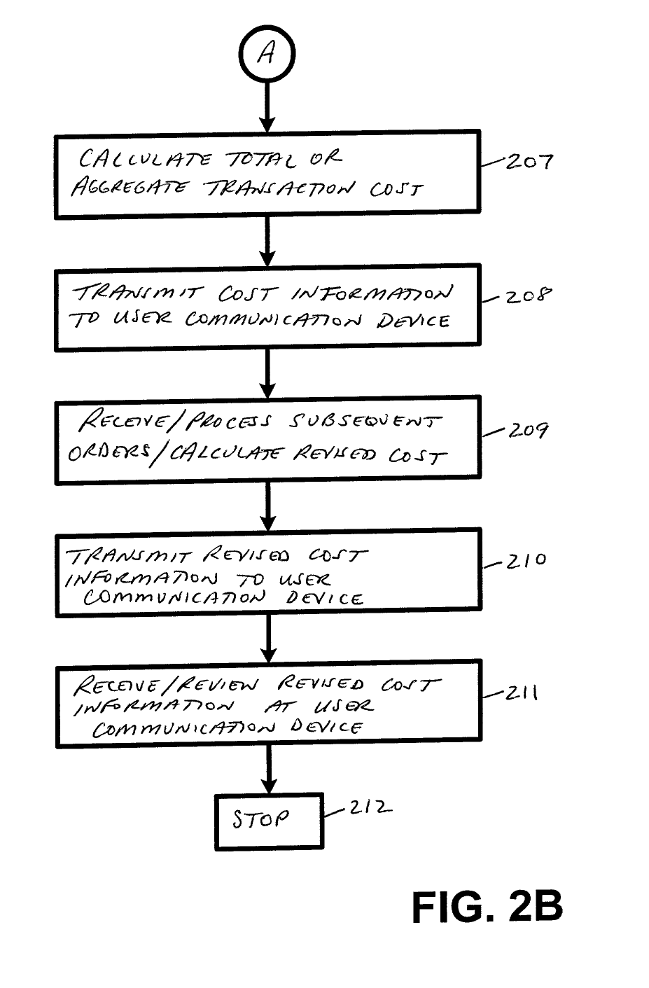

FIGS. 2A and 2B illustrates a preferred embodiment method for utilizing the apparatus 100 of the present invention, in flow diagram form. With reference to FIGS. 2A and 2B, the operation of the apparatus 100 commences at step 200. At step 201, the user accesses the central processing computer 10 via the user communication device 20. At step 202, the user requests to receive information regarding any good(s), product(s), and/or service(s), which the user is interested in ordering or purchasing. The user request and/or any information related thereto can be transmitted to the central processing computer 10.

At step 203, the central processing computer 10 will receive and process the user request and/or the user request for information and transmit information regarding the good(s), product(s), and/or service(s), along with any information regarding same to the use communication device 20. The information can include a video image, a video clip, an audio message, text material, a description, price, shipping charges (if applicable, handling charges (if applicable), taxes (if applicable), duties (if applicable), tariffs (if applicable), insurance coverage and charges (if applicable and/or if available), and/or any other charges and/or costs related to the transaction, order, or purchase.

At step 204, the user can receive and review the information on the user communication device 20. At step 205, the user can transmit his or her order information to purchase a good(s), product(s), and/or service(s), to the central processing computer 10. At step 206, the central processing computer 10 can receive the order information and process the order. At step 206, the central processing computer 10 can receive order information for any number of goods, products, and/or services.

At step 207, the central processing computer 10 can process the transaction information and calculate or compute the total or aggregate transaction cost for the order or transaction. The total or aggregate transaction cost for the order or transaction will include the cost of the respective good(s), product(s), and/or service(s), and applicable and/or associated shipping charges and/or costs, handling charges and/or costs, taxes, duties, tariffs, insurance charges and/or costs, and any other transaction-related expenses, charges, or costs.

At step 207, the central processing computer 10 can calculate or compute the total or aggregate transaction cost for the order placed by the user or purchaser. The total or aggregate transaction cost can include the cost of all of the respective good(s), product(s), and/or service(s), which are ordered, along with any applicable and/or associated total shipping charges and/or costs, total handling charges and/or costs, total taxes, duties, and/or tariffs, and/or total insurance charges and/or costs, and any other transaction-related expenses.

At step 207, the central processing computer 10 can calculate or compute any and/or all applicable, related, and/or incidental, shipping charges or costs, handling charges or costs, taxes, duties, tariffs, and/or insurance charges or costs, based upon the respective good(s), product(s), and/or service(s), any characteristics of the respective good(s), product(s), and/or service(s), the weight or other shipping considerations of or regarding the good(s), product(s), and/or service(s), handling requirements and/or handling procedures for or regarding any of the good(s), product(s), and/or service(s), required and/or applicable taxes, duties, and/or tariffs, associated with the appropriate taxing authority, the origin of, and/or the place of sale of, the respective good(s), product(s), and/or service(s), the value of the respective good(s), product(s), and/or service(s), incidence of damage for any of the respective good(s), product(s), and/or service(s), and/or any available and/or associated insurance policies and insurance premiums, charges, and/or costs, for or associated with the respective good(s), product(s), and/or service(s).

At step 207, the central processing computer 10 can also calculate and/or compute the charges or costs for any applicable shipping charges or costs, handling charges or costs, taxes, duties, tariffs, and/or insurance charges or costs for each of each respective good(s), product(s), and/or service(s), by utilizing any one or more of minimum shipping charges or costs, minimum handling charges or costs, minimum taxes, minimum duties, minimum tariffs, minimum insurance charges or costs, and/or base insurance charges or costs, for each of each respective good(s), product(s), and/or service(s), and/or any incremental shipping charges or costs, incremental handling charges or costs, incremental taxes, incremental duties, incremental tariffs, and/or incremental insurance charges or costs for each of each respective good(s), product(s), and/or service(s), maximum shipping charges or costs, maximum handling charges or costs, maximum taxes, maximum duties, maximum tariffs, and/or maximum insurance charges or costs for each of each respective good(s), product(s), and/or service(s), and/or waivers of shipping charges or costs, handling charges or costs, taxes, duties, tariffs, and/or insurance charges or costs for each of each respective good(s), product(s), and/or service(s).

The central processing computer 10 can also, at step 207, calculate or compute any of the total costs for any one or more of the applicable shipping charges or costs, handling charges or costs, taxes, duties, tariffs, and/or insurance charges or costs for each of each respective good(s), product(s), and/or service(s), for any one or more of the respective good(s), product(s), and/or service(s), and/or for the entire order of the good(s), product(s), and/or service(s).

At step 207, the central processing computer can combine the respective good(s), product(s), and/or service(s), in any appropriate manner in order to minimize any applicable and/or respective shipping applicable shipping charges or costs, handling charges or costs, taxes, duties, tariffs, and/or insurance charges or costs, which are associated with an order. For example, if a shipping carrier charges $5.95 as a set fee to ship one pound of merchandise, the central processing computer can organize the order fulfillment to combine as many goods or products into a one pound shipment as possible in order to minimize shipping charges and/or costs.

The central processing computer can also process orders so as to minimize handling charges. For example, if a vendor charges a flat rate fee to handle an order, regardless of contents of size, the central processing computer can direct that an order be arranged so as to minimize handing charges.

The central processing computer 10 can also minimize taxes, duties, and/or tariffs, by locating and ordering from taxing authorities or countries which may have lower taxes, duties, and/or tariffs. For example, if a shipment of a good can be obtained from Country A and from country B, the central processing computer, by having any relevant tax, duty, and/or tariff, information available in, and/or accessible by, its database, can compare the respective taxes, duties, and/or tariffs, identify the country with the lowest taxes, duties, and/or tariffs, and provide for shipment from the country with the lower taxes, duties, or tariffs.

The central processing computer 10 can also minimize insurance charges or costs by combining orders so as to take advantage of minimum and/or fixed insurance premiums, charges, and/or costs. For example, if goods or products can be insured for up to $100.00 for a certain flat rate insurance premium, the central processing computer 10 can arrange the order in a manner so as to maximize the value of goods or products shipped while minimizing insurance charges or costs.

The central processing computer 10 can also process any and/or all of the above charge or cost minimization information, regarding shipping charges or costs, handling charges or costs, taxes, duties, tariffs, and/or insurance charges or costs, for the order and/or for the proposed and/or arranged fulfillment thereof, in order to determine a minimum total or aggregate transaction costs for the order and/or for the respective shipping charges or costs, handling charges or costs, taxes, duties, tariffs, and/or insurance charges or cost, related thereto.

At step 207, the central processing computer 10 can also provide the user or purchaser with information regarding available shippers, shipping options, shipping costs, handling options, handling charges, available sources for the respective good(s), product(s), and/or service(s), including available taxing authorities and/or countries of origin, available insurance coverage, insurance coverage options, insurance premiums and/or costs. The user or purchaser can select the type of shipping service or mode, handling, taxing authority, and/or insurance coverage which they desire to utilize and, therefore, the charges for which he or she is willing to pay. In this manner, the user or purchaser can select the type of shipping service or mode, handling, taxing authority, and/or insurance coverage which they desire to utilize, in an interactive manner.

In another preferred embodiment, the central processing computer 10 can be programmed to select the shipping service or mode, the handling method, the taxing authority, and/or the insurer or insurance policy, based upon any criteria which can include a minimum shipping and/or handling cost, a faster delivery time, etc. and/or based upon any other criteria. The central processing computer 10 can also process and generate different shipping, handling, taxing, and/or insurance, scenarios from which the user or purchaser can select.

At step 207, the central processing computer 10 can also calculate or compute the total or aggregate transaction costs by utilizing information regarding minimum charges or costs, charge or cost exemptions, flat rate charges or costs, and/or maximum charges or costs, for any of the charges or costs for, or associated with, any of the good(s), product(s), and/or service(s), shipping charges or costs, handling charges or costs, taxes, duties, tariffs, and/or insurance charges or costs, described herein.

At step 208, the central processing computer 10 will transmit the total or aggregate transaction cost information to the user computer 20. At step 209, the central processing computer 10 can receive and process any subsequent orders from the user or purchaser and calculate or compute a revised total or aggregate transaction cost. The operation at step 209 can be repeated for any number of subsequent orders.

At step 210, the central processing computer 10 will transmit the total or aggregate transaction cost information to the user computer 20. Thereafter, at step 211, the user can receive and review the total or aggregate transaction cost information and decide whether or not to proceed to consummate the transaction and/or to proceed to the check out point and complete the transaction. Thereafter, the operation of the apparatus 100 will cease at step 212.

In another preferred embodiment, at any time prior to, contemporaneously with, or subsequent to, a total or aggregate transaction cost being calculated and/or being provided to the user, the central processing computer 10 can receive a user's defined maximum spending limit and/or a revised maximum spending limit.

Thereafter, the central processing computer 10 can compute various order combinations, options, and/or variations, involving any of the respective good(s), products(s), and/or service(s), which are being ordered, or which were previously ordered, in order to provide the user or purchaser with an order or order combination which can result in a total or aggregate transaction cost which is at or below the user's defined maximum spending limit. In this manner, the apparatus 100 and/or the central processing computer 10 can modify a user's order in order to adjust same to meet the user's defined maximum spending limit.

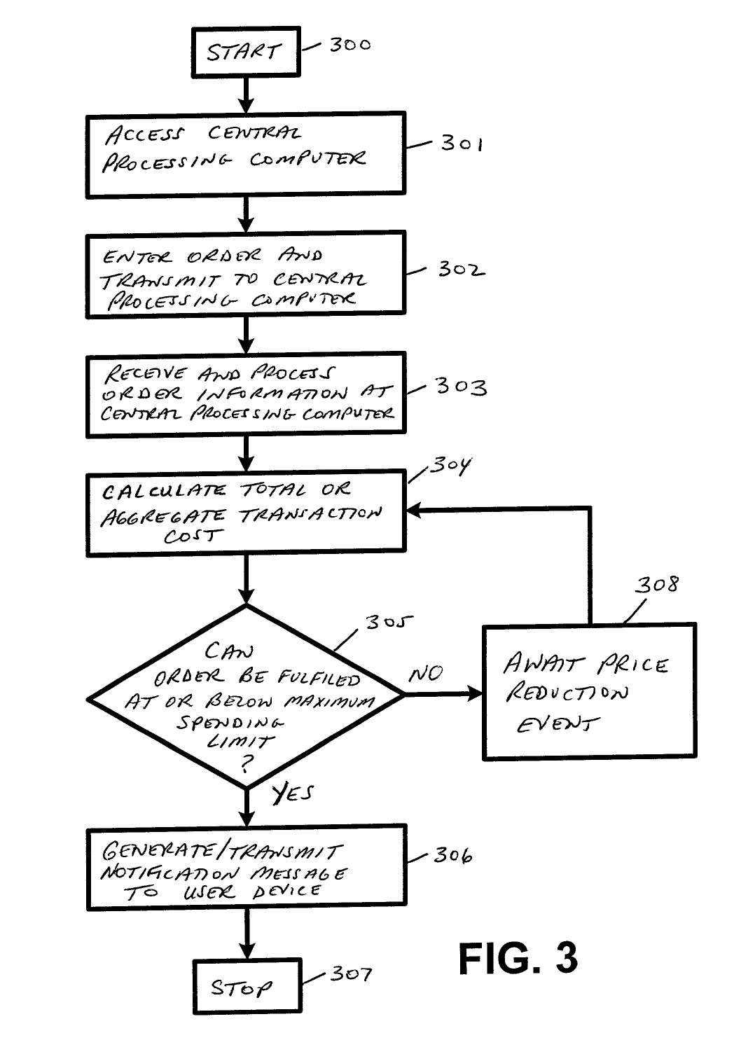

In another preferred embodiment, the apparatus 100 can also be programmed to notify a user when a total or aggregate cost of a prospective transaction falls, or has been reduced, to a certain total or aggregate transaction amount. FIG. 3 illustrates another preferred embodiment method for utilizing the apparatus 100, in flow diagram form.

The operation of the apparatus 100 commences at step 300. At step 301, the user access the central processing computer 10 via the user communication device 20. At step 302, the user can enter his or her order for any good(s), product(s), and/or service(s), and/or any combination of good(s), product(s), and/or service(s), along with a user-defined maximum spending limit and transmit the entered information to the central processing computer 10.

At step 303, the central processing computer 10 will receive and process the order information and the user-defined maximum spending limit information. At step 304, the central processing computer 10 will attempt to fulfill the order at or under the user-defined maximum spending limit. At step 304, the central processing computer 10 will also calculate or compute the total or aggregate transaction cost by identifying and calculating any and all prices, charges, or costs, which are associated with, relevant to, related to, and/or incidental to, the order.

The total or aggregate transaction cost can include the cost of all of the respective good(s), product(s), and/or service(s), which are ordered, along with any applicable and/or associated total shipping charges and/or costs, total handling charges and/or costs, total taxes, duties, and/or tariffs, and/or total insurance charges and/or costs, and any other transaction-related expenses.

At step 304, the central processing computer 10 can calculate or compute any and/or all applicable, related, and/or incidental, shipping charges or costs, handling charges or costs, taxes, duties, tariffs, and/or insurance charges or costs, based upon the respective good(s), product(s), and/or service(s), any characteristics of the respective good(s), product(s), and/or service(s), the weight or other shipping considerations of or regarding the good(s), product(s), and/or service(s), handling requirements and/or handling procedures for or regarding any of the good(s), product(s), and/or service(s), required and/or applicable taxes, duties, and/or tariffs, associated with the appropriate taxing authority, the origin of, and/or the place of sale of, the respective good(s), product(s), and/or service(s), the value of the respective good(s), product(s), and/or service(s), incidence of damage for any of the respective good(s), product(s), and/or service(s), and/or any available and/or associated insurance policies and insurance premiums, charges, and/or costs, for or associated with the respective good(s), product(s), and/or service(s).

At step 304, the central processing computer 10 can also calculate and/or compute the charges or costs for any applicable shipping charges or costs, handling charges or costs, taxes, duties, tariffs, and/or insurance charges or costs for each of each respective good(s), product(s), and/or service(s), by utilizing any one or more of minimum shipping charges or costs, minimum handling charges or costs, minimum taxes, minimum duties, minimum tariffs, minimum insurance charges or costs, and/or base insurance charges or costs, for each of each respective good(s), product(s), and/or service(s), and/or any incremental shipping charges or costs, incremental handling charges or costs, incremental taxes, incremental duties, incremental tariffs, and/or incremental insurance charges or costs for each of each respective good(s), product(s), and/or service(s), maximum shipping charges or costs, maximum handling charges or costs, maximum taxes, maximum duties, maximum tariffs, and/or maximum insurance charges or costs for each of each respective good(s), product(s), and/or service(s), and/or waivers of shipping charges or costs, handling charges or costs, taxes, duties, tariffs, and/or insurance charges or costs for each of each respective good(s), product(s), and/or service(s).

The central processing computer 10 can also, at step 304, calculate or compute any of the total costs for any one or more of the applicable shipping charges or costs, handling charges or costs, taxes, duties, tariffs, and/or insurance charges or costs for each of each respective good(s), product(s), and/or service(s), for any one or more of the respective good(s), product(s), and/or service(s), and/or for the entire order of the good(s), product(s), and/or service(s).

At step 304, the central processing computer can combine the respective good(s), product(s), and/or service(s), in any appropriate manner in order to minimize any applicable and/or respective shipping applicable shipping charges or costs, handling charges or costs, taxes, duties, tariffs, and/or insurance charges or costs, which are associated with an order.

The central processing computer can also process orders so as to minimize handling charges. The central processing computer 10 can also minimize taxes, duties, and/or tariffs, by locating and ordering from taxing authorities or countries which may have lower taxes, duties, and/or tariffs.

The central processing computer 10 can also minimize insurance charges or costs by combining orders so as to take advantage of minimum and/or fixed insurance premiums, charges, and/or costs.

The central processing computer 10 can also process any and/or all of the above charge or cost minimization information, regarding shipping charges or costs, handling charges or costs, taxes, duties, tariffs, and/or insurance charges or costs, for the order and/or for the proposed and/or arranged fulfillment thereof, in order to determine a minimum total or aggregate transaction costs for the order and/or for the respective shipping charges or costs, handling charges or costs, taxes, duties, tariffs, and/or insurance charges or cost, related thereto.

At step 304, the central processing computer 10 can also provide the user or purchaser with information regarding available shippers, shipping options, shipping costs, handling options, handling charges, available sources for the respective good(s), product(s), and/or service(s), including available taxing authorities and/or countries of origin, available insurance coverage, insurance coverage options, insurance premiums and/or costs.

The user or purchaser can select the type of shipping service or mode, handling, taxing authority, and/or insurance coverage which they desire to utilize and, therefore, the charges for which he or she is willing to pay. In this manner, the user or purchaser can select the type of shipping service or mode, handling, taxing authority, and/or insurance coverage which they desire to utilize, in an interactive manner.

In another preferred embodiment, the central processing computer 10 can be programmed to select the shipping service or mode, the handling method, the taxing authority, and/or the insurer or insurance policy, based upon any criteria which can include a minimum shipping and/or handling cost, a faster delivery time, etc. and/or based upon any other criteria. The central processing computer 10 can also process and generate different shipping, handling, taxing, and/or insurance, scenarios from which the user or purchaser can select.

At step 304, the central processing computer 10 can also calculate or compute the total or aggregate transaction costs by utilizing information regarding minimum charges or costs, charge or cost exemptions, flat rate charges or costs, and/or maximum charges or costs, for any of the charges or costs for, or associated with, any of the good(s), product(s), and/or service(s), shipping charges or costs, handling charges or costs, taxes, duties, tariffs, and/or insurance charges or costs, described herein.

At step 305, the central processing computer 10 will determine whether the user's order can be fulfilled at or below the user-defined maximum spending limit. If, at step 305, it is determined that the user's order can be fulfilled at or below the user-defined maximum spending limit, then the central processing computer 10 will, at step 306, notify the user and, if the user still desires to engage in the transaction or place the order, process and/or consummate the order for the user.

At step 306, the central processing computer 10 can generate a notification message which can be any one or more of an e-mail message(s), a telephone message(s), a beeper or pager message(s), an instant messaging message(s), a physical mail delivery or deliveries, an electronic data transmission(s), and/or any other suitable communication(s).

The notification message can contain any information regarding the order, its fulfillment, any terms of fulfillment, and/or any other order information and/or transaction information. At step 306, the central processing computer 10 will also transmit the notification message to the user communication device 20. The notification message can be transmitted to the user communication device 20 via any suitable or appropriate communication method and/or technique. Thereafter, the operation of the central processing computer 10 will cease at step 307.

If, at step 305, it is determined that the user's order cannot be fulfilled at or below the user-defined maximum spending limit, the central processing computer 10 will proceed to step 308 and await a price reduction event. The price reduction event can be any reduction in the selling price or purchase price for any of the respective good(s), product(s), and/or service(s), any reduction in any applicable, associated, and/or incidental, shipping charges or costs, any reduction in any applicable, associated, and/or incidental, handing charges or costs, any reduction in any applicable, associated, and/or incidental, taxes, duties, and/or tariffs, any reduction in any applicable, associated, and/or incidental, insurance charges or costs, and/or any reduction in any other transaction and/or transaction-related charges or costs.

The price reduction event can also be a waiver(s) of shipping charges or costs, handling charges or costs, taxes, duties, tariffs, and/or insurance charges or costs, for each of each respective good(s), product(s), and/or service(s), and/or an exemption(s) from having to pay shipping charges or costs, handling charges or costs, taxes, duties, tariffs, and/or insurance charges or costs, for each of each respective good(s), product(s), and/or service(s).

The central processing computer 10, in the preferred embodiment, can be programmed to detect any of the herein-described reductions in prices, charges, or costs. Upon the detection of a price reduction and/or a reduction in any of the herein-described prices, charges, and/or costs, which are or which may be associated with, relevant to, related to, and/or incidental to, the order, the central processing computer 10 will proceed to step 304 and the above-described process will be repeated by utilizing any of the reduced and/or revised price, charge, or cost, information.

The user can access the central processing computer 10 via the user communication device 20 at any time in order to change any of the herein-described order information, the user-defined maximum spending limit, and/or the user-defined maximum spending limit information.

In any and/or all of the herein-descried embodiments, the apparatus and method of the present invention can utilize intelligent agents, software agents, and/or mobile agents, in order to act for, or on behalf of, any of the users of the apparatus 100 and/or any of the central processing computers 10, user computers 20, vendor computers 30, and/or shipper computers 40, described herein.

The apparatus 100 and/or any of the central processing computers 10, the user computers 20, the vendor computers 30, and/or the shipper computers 40, can also be programmed to be self-activating and/or activated automatically.

While the present invention has been described and illustrated in various preferred and alternate embodiments, such descriptions are merely illustrative of the present invention and are not to be construed to be limitations thereof. In this regard, the present invention encompasses any and/or all modifications, variations, and/or alternate embodiments, with the scope of the present invention being limited only by the claims which follow.

What is claimed is:

1. An apparatus for providing transaction cost information, comprising:
a memory device for storing information regarding at least one of a cost of at least one of a good, a product, and a service, a shipping cost, a handling cost, a tax, a duty, a tariff, and an insurance cost;
a receiver for receiving information regarding at least one of a transaction and an order involving at least one of a good(s), product(s), and a service(s);
a processor for processing said information regarding a transaction in conjunction with said information regarding at least one of a cost of at least one of a good, a product, and a service, a shipping cost, a handling cost, a tax, a duty, a tariff, and an insurance cost, wherein said processor calculates a total cost of said transaction, wherein said total cost of said transaction includes a cost of said at least one of a good, a product, and a service, and any applicable at least one of a shipping cost, a handling cost, a tax, a duty, a tariff, and an insurance cost, associated with said transaction, and further wherein said processor generates a transaction total cost message, wherein said transaction total cost message contains information regarding the total cost of said transaction; and
a transmitter for transmitting said transaction total cost message to a communication device associated with a user.

2. The apparatus of claim 1, wherein said processor determines a running total cost of said transaction.

3. The apparatus of claim 1, wherein said processor determines a running total cost of said transaction in real-time.

4. The apparatus of claim 1, wherein said transmitter transmits said running total cost of said transaction to a communication device associated with the user.

5. The apparatus of claim 1, wherein said apparatus is utilized at least one of on, over, and in conjunction with the Internet, the World Wide Web, a telephone network, a telecommunication network, a digital communication network, a satellite communication network, a wireless communication network, a personal communication services network, a broadband communication network, a bluetooth communication network, and further wherein the user communication device is at least one of a computer, a computer system, a group of computers, a telephone, a personal computer, a wireless telephone, a personal digital assistant, a video telephone, a personal communication device, a wireless device, a handheld device, and a palmtop device.

6. The apparatus of claim 1, wherein said total transaction cost information is transmitted to the user communication device at least one of prior to, contemporaneously with, and subsequent to, engaging in a transaction.

7. The apparatus of claim 1, wherein said apparatus provides information regarding at least one of a good(s), a product(s), and a service(s), and further wherein said information contains at least one of a video image, a video clip, an audio message, text material, a description, price, a shipping charge, a handling charge, a tax, a duty, a tariff, and an insurance charge.

8. The apparatus of claim 1, wherein said processor calculates said total transaction cost based upon at least one of the respective at least one of good(s), product(s), and/or service(s), characteristics of at least one of the good(s), product(s), and/or service(s), the at least one of weight and shipping considerations regarding at least one of the good(s), product(s), and/or service(s), at least one of handling requirements and handling procedures regarding any of the at least one of good(s), product(s), and/or service(s), required at least one of taxes, duties, and tariffs, the value of the at least one of good(s), product(s), and/or service(s), an incidence of damage for any of the at least one of good(s), product(s), and/or service(s), and at least one of an insurance policy, premiums, charges, and costs, for the at least one of good(s), product(s), and/or service(s).

9. The apparatus of claim 1, wherein said processor calculates at least one of at least one of shipping costs, handling costs, taxes, duties, tariffs, and insurance costs, at least one of minimum shipping costs, minimum handling costs, minimum taxes, minimum duties, minimum tariffs, and minimum insurance costs, at least one of maximum shipping costs, maximum handling costs, maximum taxes, maximum duties, maximum tariffs, and maximum insurance costs, at least one of waived shipping costs, waived handling costs, waived taxes, waived duties, waived tariffs, and waived insurance costs, and at least one of incremental shipping costs, incremental handling costs, incremental taxes, incremental duties, incremental tariffs, and incremental insurance costs.

10. The apparatus of claim 1, wherein said processor calculates a minimum total transaction cost.

11. The apparatus of claim 1, wherein said processor at least one of places, processes, and arranges, an order in order to minimize at least one of said total transaction cost, a shipping cost, a handling cost, a tax, a duty, a tariff, and an insurance cost.

12. The apparatus of claim 1, wherein said apparatus provides information regarding at least one of shippers, shipping options, shipping costs, handling options, handling charges, available sources for the at least one of good(s), product(s), and/or service(s), taxes, duties, tariffs, available insurance coverage, insurance coverage options, insurance premiums, and insurance costs.

13. The apparatus of claim 1, wherein said apparatus can be programmed to select at least one of a shipping service, a shipping mode, a handling method, a taxing authority, an insurer, and an insurance policy, based on criteria which can include at least one of a minimum shipping cost, a minimum handling cost, and a faster delivery time.

14. The apparatus of claim 1, wherein said receiver receives a user-defined maximum spending limit.

15. The apparatus of claim 15, wherein said processor processes said transaction in conjunction with said user-defined maximum spending limit.

16. The apparatus of claim 1, wherein said apparatus can determine at least one of an order combination, an order option, and an order variation.

17. The apparatus of claim 1, wherein said apparatus can adjust an order to meet at least one of a user-defined maximum spending limit and a minimum cost.

18. The apparatus of claim 1, wherein said apparatus provides notification to a user at least one of when a total cost of a prospective transaction at least one of falls, and is reduced, to a certain total transaction amount.

19. An apparatus for providing transaction cost information, comprising:
a memory device for storing information regarding at least one of a cost of at least one of a good, a product, and a service, a shipping cost, a handling cost, a tax, a duty, a tariff, and an insurance cost;
a receiver for receiving information regarding at least one of a transaction and an order involving at least one of a good(s), product(s), and a service(s);
a processor, wherein said processor detects a price reduction event one of involving and related to a cost of at least one of a good, a product, and a service, a shipping cost, a handling cost, a tax, a duty, a tariff, and an insurance cost, and further wherein said processor processing said information regarding a transaction in conjunction with said information regarding at least one of a reduced cost of at least one of a good, a product, and a service, a shipping cost, a handling cost, a tax, a duty, a tariff, and an insurance cost, wherein said processor calculates a total cost of said transaction, wherein said total cost of said transaction includes a cost of said at least one of a good, a product, and a service, and any applicable at least one of a shipping cost, a handling cost, a tax, a duty, a tariff, and an insurance cost, associated with said transaction, and further wherein said processor generates a transaction total cost message, wherein said transaction total cost message contains information regarding the total cost of said transaction; and
a transmitter for transmitting said transaction total cost message to a communication device associated with a user.

20. A method for providing transaction cost information, comprising:
storing information regarding at least one of a cost of at least one of a good, a product, and a service, a shipping cost, a handling cost, a tax, a duty, a tariff, and an insurance cost;
receiving information regarding at least one of a transaction and an order involving at least one of a good(s), product(s), and a service(s);
processing said information regarding a transaction in conjunction with said information regarding at least one of a cost of at least one of a good, a product, and a service, a shipping cost, a handling cost, a tax, a duty, a tariff, and an insurance cost;
calculating a total cost of said transaction, wherein said total cost of said transaction includes a cost of said at least one of a good, a product, and a service, and any applicable at least one of a shipping cost, a handling cost, a tax, a duty, a tariff, and an insurance cost, associated with said transaction;
generating a transaction total cost message, wherein said transaction total cost message contains information regarding the total cost of said transaction; and
transmitting said transaction total cost message to a communication device associated with a user.
